(19) United States
(12) Patent Application Publication
(10) Pub. No.: US 2015/0028659 A1
(43) Pub. Date: Jan. 29, 2015

(54) Bicycle Wheel Rim Decoration

(71) Applicants: Vicken Jabourian, San Diego, CA (US); Shant Jabourian, San Diego, CA (US)

(72) Inventors: Vicken Jabourian, San Diego, CA (US); Shant Jabourian, San Diego, CA (US)

(21) Appl. No.: 14/042,547

(22) Filed: Sep. 30, 2013

Related U.S. Application Data
(60) Provisional application No. 61/744,603, filed on Oct. 1, 2012.

(51) Int. Cl. B60B 7/00; B60B 7/06; B60B 7/01

(52) U.S. Cl. CPC B60B 7/0006; B60B 7/01; B60B 7/06; B60B 7/006
USPC 301/37.24; 156/60

(57) ABSTRACT

An appliqué for adoring a bicycle wheel rim comprises a series of arced members bearing adhesive on one side, each adapted to partially cover a portion of the wheel rim. The arced members may be reflective, phosphorescent, or may have customized and customizable designs incorporated thereon. The arced members have complimentary ends such that when alighted end-to-end they cover the entire bicycle rim. To apply the arced members, a user first peels off a backer paper to expose the adhesive side of the arced member, applies the arced member to a wheel rim, then uses a smoothing tool to remove any bubbles, subsequent arced members are applied in a similar manner to cover the wheel rim.

This application claims the benefit of the filing date of provisional application No. 61/744,603, filed on Oct. 1, 2012.

### BACKGROUND

U.S. Pat. No. 4,285,573 to Stone discloses a corrugated light reflective ring made from thin, flexible material having a light reflective surface on both sides thereof and adapted to be intertwined between the spokes of a bicycle wheel. Although Stone contemplates a ring of reflective material, it is difficult to install and remove since it must be intertwined between the spokes of a bicycle wheel. Also, Stone is unattractive since it provides only a reflective surface and may not be modified according to a user's preference.

U.S. Pat. No. 6,517,166 to Chen discloses a wheel rim including a transparent adhesive layer provided on the surface of the wheel rim, a light-reflective particle layer which is substantially free of any superimposed or overlapping particles and which is formed by spreading solely and uniformly dry light-reflective particles on the transparent adhesive layer and contacting directly the particles with the transparent adhesive layer, the particles having dimensions larger than the thickness of the transparent adhesive layer so that some of the dry light-reflective particles which do not contact the transparent adhesive layer can be allowed to fall off the transparent adhesive layer by gravity, and a transparent protective layer provided on the light reflective particle layer. While Chen proposes a wheel rim with an adhesive layer including a light reflective coating, it is difficult to install and remove, and fails to provide any option for decorative elements.

There is therefore a need for a decorative wheel rim covering which is easy to apply and remove, and which allows a user to choose among various decorative elements for applying a unique and stylish appearance to a wheel rim. There is also a need for a decorative wheel rim covering that protects the rim from scratches and light cosmetic damage, which allows for repeated customization and styling according to preference, which is inexpensive, and which provides extra safety to bicyclists riding at night.

### SUMMARY

An appliqué designed for application to a wheel rim may have decorative properties, and may function in addition as a safety device by providing a bright color, reflective properties, glow in the dark (i.e., phosphorescent), or similar attributes promoting visibility. An individual appliqué is preferably an arced member with a curvature that matches or is complimentary to the curvature of a wheel rim. In a preferred embodiment, an arc comprising one quarter of the wheel rim is contemplated. In other embodiments, arced members comprising other lengths are contemplated, such as an arc of ⅓ the circumference of the wheel rim, ⅛ the circumference of the wheel rim, or even a semicircular arc comprising ½ the circumference of the wheel rim for example.

Preferably, each arced member will be constructed of a malleable self-adhesive film. In a preferred embodiment a polyvinyl chloride (PVC) film is contemplated, including an intermediate calendered PVC film. Other materials may include vinyl or similar films. Ideally, the film should be relatively thin. One preferred thickness is 2.5 mil, although other thicknesses are contemplated. The arced member is self-adhesive by virtue of an adhesive applied to one side of the film. In a preferred embodiment, a polyacrylate adhesive may be used, although other adhesives sufficient to anchor the film to a wheel rim are contemplated. Due to the adhesive applied to the film, a coated paper, such as a silicon coated paper may protect the adhesive surface prior to installation.

When installed, each arced member covers a section of the wheel rim. In this manner, when a series of arced members are applied end-to-end on the wheel rim, the entire rim is covered. For this reason, the arced members preferably have complimentary ends, wherein when a series of arced members are applied end-to-end on the wheel rim, the entire circumference of the wheel rim on one side is covered by the appliqué. Also, since the ends of each arced member are complimentary, a pattern may be established across several arced members to achieve a uniform decorative pattern or image.

In one embodiment a deep V wheel rim is contemplated for affixing the appliqué. Because the distance from the rim flange to the hub support in a deep V rim is pronounced, the appliqué is more visible, including patterns or images represented on the appliqué. In addition, deep V rims are typically employed on fixed gear bicycles. In instances where the appliqué is applied to a fixed gear bicycle without caliper brakes, it is preferably wide enough to extend from the rim flange all the way to the hub support, such as a spoke nipple or similar support. In instances where caliper brakes are used, the appliqué may be constructed to have a width extending only from the hub support to the portion of the wheel rim engaged by the caliper brakes.

The physical structure of the appliqué having been described, a method of manufacture and application will now be discussed.

In order to produce the appliqué, one or more arced members are formed, each having a curvature complimentary to the curvature of the wheel rim. Preferably the arced members are formed such that their ends are complimentary, and such that arranging them end-to-end around a wheel rim will cover the entire circumference of the rim. An adhesive is applied to one side of the arced member, and a non-stick coated covering applied to the adhesive side.

Preferably, the appliqué will be manufactured as a kit for decorating a wheel rim, including a bicycle wheel rim. In such an embodiment, the kit will ideally include an adhesive applicator for affixing the arced members to the rim, and a smoothing tool for removing bubbles from under the arced members as they are applied.

In application, a user obtains a desirable appliqué bearing an image, a particular color, a phosphorescent coating, or other visual characteristics as desired. Beginning at a predetermined position on a wheel rim, the user removes the backing paper from an arced member and applies the arced member to the wheel rim, travelling from one end of the arced member to the other. As necessary, the user may apply additional adhesive using an adhesive applicator as desired. With the arced member affixed to the wheel rim, the user then uses the smoothing tool to drive out any unwanted air bubbles. Additional arced members may then be applied as desired around the circumference of the wheel rim.

### BRIEF DESCRIPTION OF THE FIGURES

FIG. 1 shows a series of arced members, together forming an appliqué for applying to a wheel rim.

FIG. 2 shows the manner in which the arced members adhere to the wheel rim.

FIG. 3 shows the first stage of an appliqué being applied to a wheel rim.

FIG. 4 shows the second stage of an appliqué being applied to a wheel rim.

FIG. 5 shows a second appliqué being applied to a wheel rim.

FIG. 6 shows a decorated wheel rim after application of the appliqué.

FIG. 7 shows an appliqué applied to a bicycle wheel rim.

### REFERENCE NUMBERS

10. Appliqué
12. Arced Member
14. Ends
16. Wheel Rim
18. Uninterrupted Ring
20. Rim Flange
22. Hub Supports
24. Applicator Fluid Dispenser
26. Smoothing Tool

### DESCRIPTION

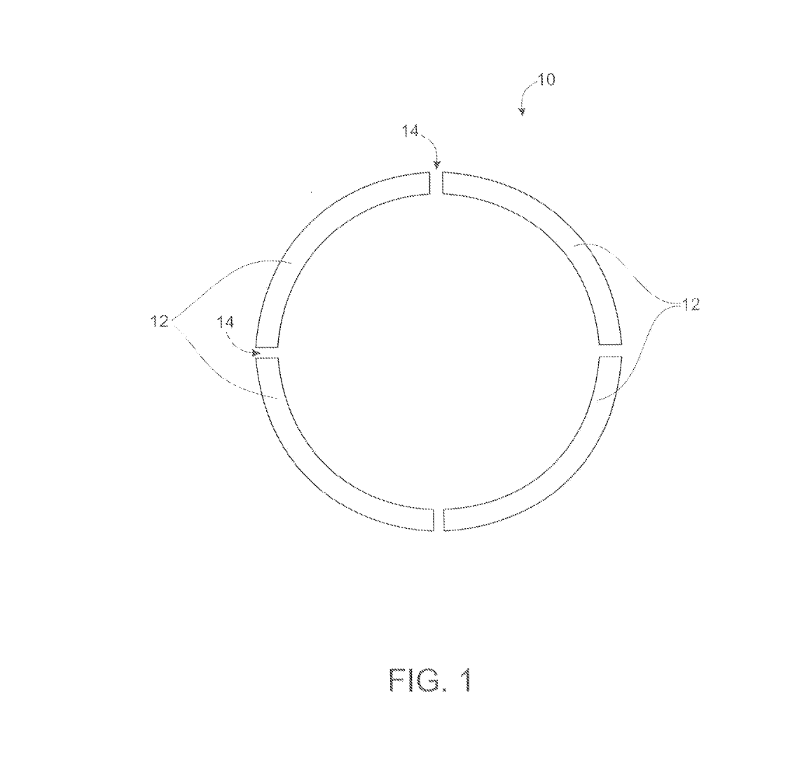

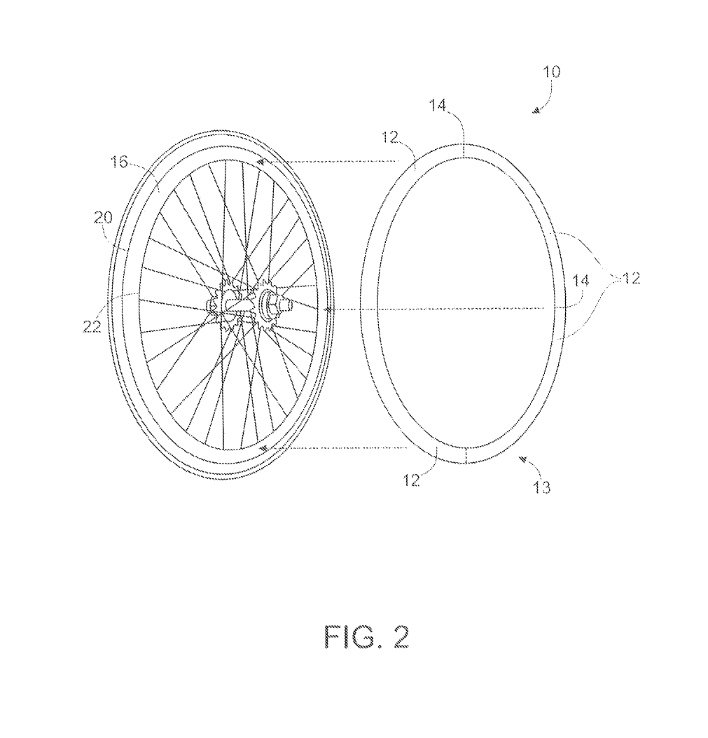

Referring to FIG. 1, an appliqué 10 comprises a series of semi-circular arced members 12 which are used to create an uninterrupted ring for application to a wheel rim (not shown). In the illustrated embodiment a bicycle wheel rim is contemplated, although other types of rims may be adorned with the appliqué 10. Each arced member 12 has extreme ends 14 which are complimentary to the ends 14 of other arced members 12. In this manner, the arced members 12 may be brought together to form an uninterrupted ring 18 (see FIG. 2). As shown in this view, four arced members 12, each representing a quarter circle are used to complete the appliqué 10. In other embodiments, the arced members may be ⅓ of a circle, ⅛ of a circle, or even a semi-circle extending half way around the circumference of a wheel rim 16 (see FIG. 2).

Referring to FIG. 2, an appliqué 10 is shown as it would be positioned on a wheel rim 16. As shown, each arced member 12 is assembled end 14 to end 14 to form a complete appliqué 10 which forms an uninterrupted ring 18 for covering an entire side of the wheel rim 16. In one preferred embodiment, a deep V wheel rim 16 is contemplated, and as these types of rims are typically installed on fixed gear bicycles (not shown) without brakes, the appliqué 10 extends from the rim flange 20 to the hub supports 22, which may comprise spoke nipples (not shown). Preferably, each appliqué 10 may include extra arced members 12 for use in the event of damage during installation. Additionally, the appliqué 10 will ideally be provided in a kit (not shown) in which sufficient arced members 12 are provided for adorning both sides of a wheel rim 16.

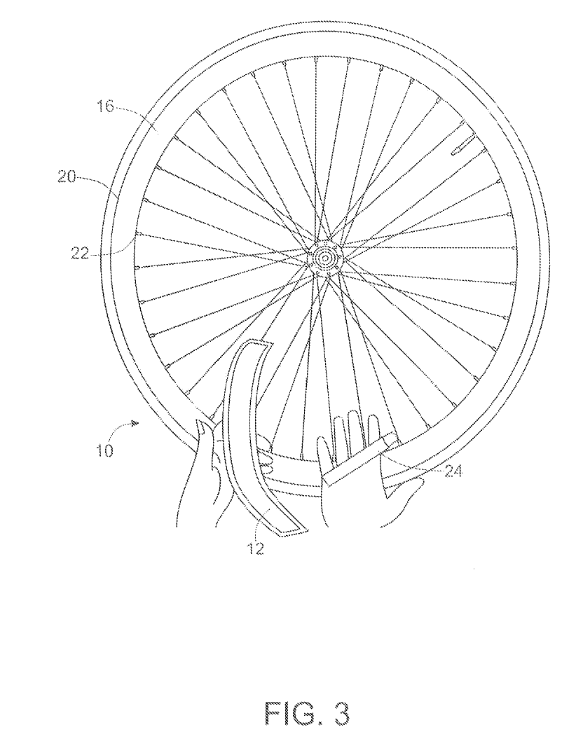

Referring to FIG. 3, an appliqué 10 is shown in the process of installation. Initially a user obtains a single arced member 12 for application to a wheel rim 16. In addition to the arced member 12, an applicator fluid dispenser 24 may be used. The applicator fluid dispenser 24 includes a fluid that may be applied to the adhesive side of the arced member 12 thereby allowing a user to slide it around after applying it to the wheel rim 16 for an accurate installation.

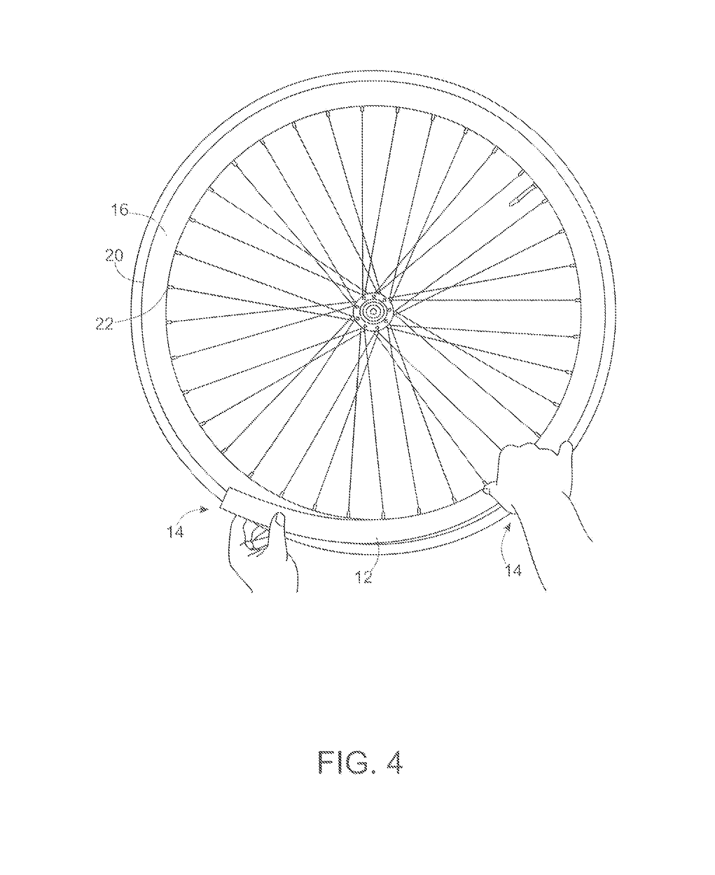

Referring to FIG. 4, a user applies one end 14 of the arced member 12 to a wheel rim 16, and places the remaining length of the arced member 12, aligning it with the curvature of the rim until the entire arced member 12 is attached to the rim. The applicator fluid may have been already applied to the arced member 12 to assist with proper positioning after adhesion to the wheel rim 16.

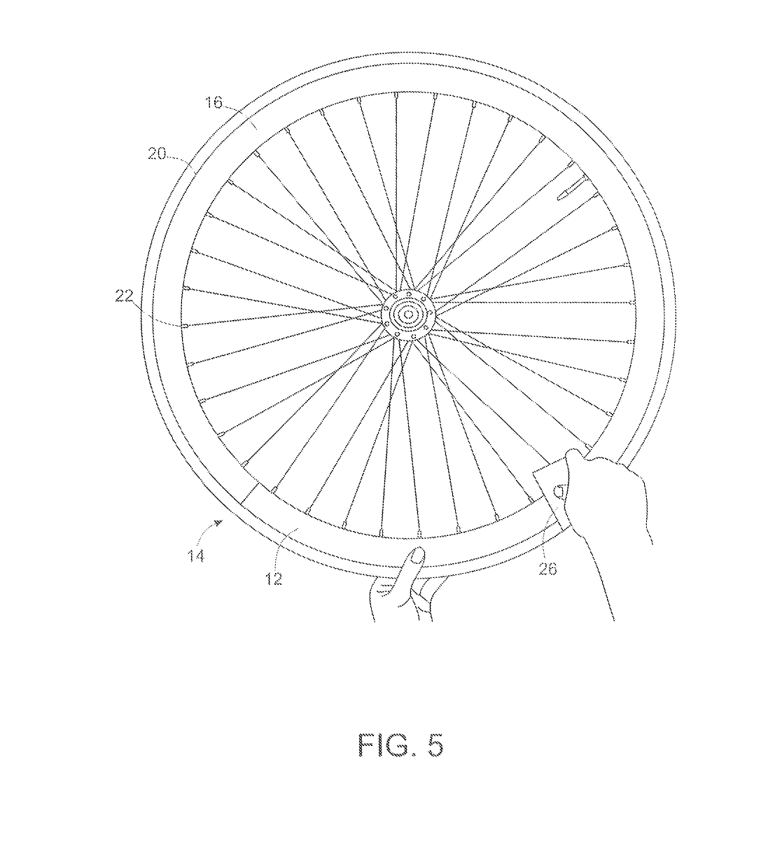

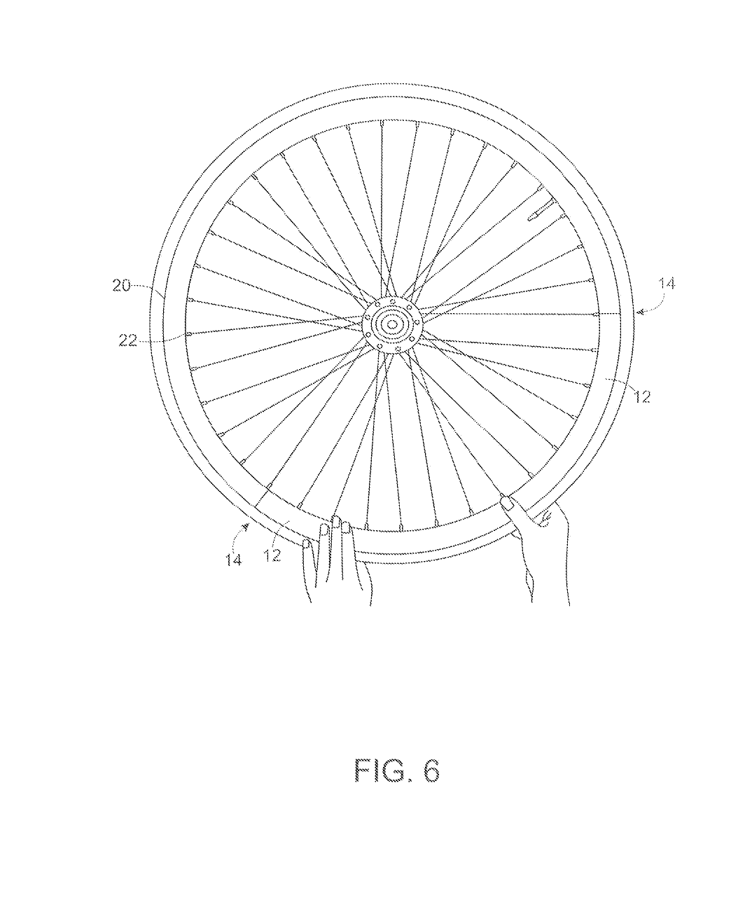

Referring to FIG. 5, after the arced member 12 is properly adhered to the wheel rim 16, a smoothing tool 26 may be used to force out bubbles between the arced member 12 and wheel rim 16 for a smooth appearance. Referring to FIG. 6, once a first arced member 12 is in place on the wheel rim 16, another arced member 12 may be installed such that the arced members 12 are abutting. Since the ends 14 of each arced member 12 are complimentary, a uniform appearance is created on the wheel rim 16.

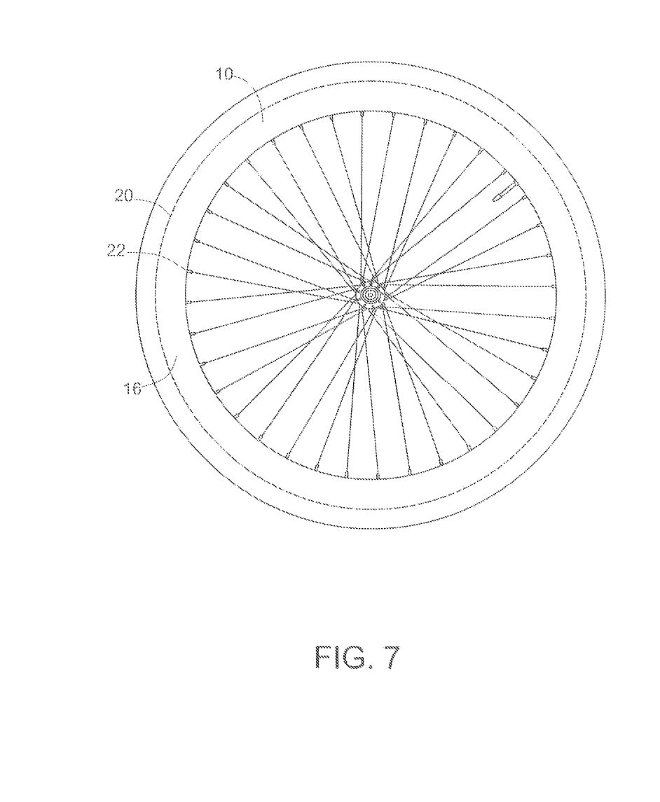

FIG. 7 shows an appliqué 10 applied to a bicycle wheel rim 16. The appliqué may be a bright color or phosphorescent to provide additional safety for night time bicycle riding. With an appliqué 10 applied to both sides of a wheel rim 16, the entire wheel glows or shines when hit with direct light. Additionally, the appliqué 10 may comprise custom prints and patterns, including customizable patterns according to user preference.

While the apparatus and method have been described in detail with reference to specific embodiments thereof, it will be apparent to one skilled in the art that various changes and modifications can be made therein without departing from the spirit and scope thereof. Thus, it is intended that the present description cover the modifications and variations of the apparatus and method provided they come within the scope of the appended claims and their equivalents.

What is claimed is:

1. An appliqué for a wheel rim having two sides and a hub support, comprising:
an arced member having a curvature complimentary to the curvature of the wheel rim;
the arced member having a length corresponding circumferentially to a section of one side of the wheel rim;
the arced member having an adhesive applied to one side; and
the arced member having complimentary ends, wherein when a series of arced members are applied end-to-end on the wheel rim, an entire circumference of wheel rim on one side is covered by the appliqué.

2. The appliqué of claim 1 wherein the wheel rim is a deep V wheel rim.

3. The appliqué of claim 1 wherein the arced member has a width equal to the distance between the hub support and a rim flange.

4. The appliqué of claim 1 wherein the hub support is a spoke nipple.

5. The appliqué of claim 1 wherein the arced member is light reflective.

6. The appliqué of claim 1 wherein the arced member is phosphorescent.

7. The appliqué of claim 1 wherein the arced member comprises a decorative pattern.

8. The appliqué of claim 1 wherein the decorative pattern aligns between the complimentary ends of the arced members.

9. The appliqué of claim 1 wherein the arced, member comprises a calendered film, including an intermediate calendered PVC film.

10. The appliqué of claim 1 wherein the adhesive comprises a polyacrylate adhesive.

11. A method of applying a wheel rim appliqué comprising the steps of;
forming an arced member having a curvature complimentary to the curvature of the wheel rim;
forming an arced member having ends complimentary with additional arced members:
applying an adhesive to one side the arced member; and
applying a coated paper to the adhesive.

12. The method of claim 11 further comprising the step of providing an adhesive applicator.

13. The method of claim 11 further comprising the step of providing a smoothing tool for removing air bubbles during application.

14. An appliqué for a wheel rim having a rim flange and spoke nipples, comprising:
an arced member having a curvature complimentary to the curvature of the wheel rim:
the arced member having a length corresponding circumferentially to a section of one side of the wheel rim;
the arced member having a width corresponding to the distance between the rim flange and the spoke nipples:
the arced member having an adhesive applied to one side; and
the arced member having complimentary ends, wherein when a series of arced members are applied end-to-end on the wheel rim, one side of the wheel rim is covered by the appliqué.
